(19) United States
(12) Patent Application Publication
(10) Pub. No.: US 2006/0028587 A1
(43) Pub. Date: Feb. 9, 2006

(54) TV tuner

(76) Inventor: Juen Tien Peng, Chung Li (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/911,590

(22) Filed: Aug. 5, 2004

(51) Int. Cl. H04N 5/46

(52) U.S. Cl. 348/731; 348/729

(57) ABSTRACT

A TV tuner includes a first mixing stage for first intermediate frequency transformation and a second mixing stage connected to the first mixing stage for second intermediate frequency transformation. When the TV tuner receives a ground TV signal, the second mixing stage is functioned as a mixer for the second intermediate frequency transformation. When the TV tuner receives an FM broadcasting signal, the second mixing stage is functioned as a phase comparison stage which connects to an integrator and a mixing oscillator thereby forming a PPL demodulator.

### BACKGROUND OF THE INVENTION

1. Field of the Invention

The present invention relates to a TV tuner, and particularly to a TV tuner which can receive ground TV signals and frequency modulation (FM) broadcasting signals.

2. Prior Art

A conventional TV tuner is generally used to receive a ground TV signal such as a cable TV signal and a radiovision signal. The received signal is transformed to a first intermediate frequency through a first mixing stage, and then further transformed to a second intermediate frequency through a second mixing stage, and finally transmitted to an intermediate frequency amplifier. As to receiving a satellite or FM broadcasting signal, the received signal is transformed to an intermediate frequency through a first mixing stage as mentioned in receiving the ground TV signal, and then is transmitted to an FM/PPL (phase locked logic) demodulator. So two types of tuners are required for receiving a satellite signal and a ground signal respectively. However, a conventional TV is usually configured with one type of tuner which results in failure in receiving both of the satellite signal and the ground signal. Furthermore, it is desired that a TV may have more functions. However, when both types of tuners are configured in a TV, cost of the TV is increased.

Therefore, it is required to improve the conventional TV tuner.

### SUMMARY OF THE INVENTION

Accordingly, an object of the present invention is to provide a TV tuner which can receive both of a ground TV signal and an FM broadcasting signal thereby reducing cost of a TV.

Another object of the present invention is to provide a TV tuner which can receive both of a ground TV signal and an FM broadcasting signal thereby increasing functions of a TV.

To achieve the above-mentioned objects, a TV tuner in accordance with the present invention includes a first mixing stage for first intermediate frequency transformation and a second mixing stage connected to the first mixing stage for second intermediate frequency transformation. When the TV tuner receives a ground TV signal, the second mixing stage is functioned as a mixer for the second intermediate frequency transformation. When the TV tuner receives an FM broadcasting signal, the second mixing stage is functioned as a phase comparison stage which connects to an integrator and a mixing oscillator thereby forming a PPL demodulator.

The various objects and advantages of the present invention will be more readily understood from the following detailed description when read in conjunction with the appended drawings, in which:

### BRIEF DESCRIPTION OF THE DRAWINGS

FIG. 1 is a functional block diagram of a TV tuner of the present invention;

FIG. 2 is a block diagram showing an application of the TV tuner; and

FIG. 3 is a circuit diagram of FIG. 2.

### DESCRIPTION OF THE PREFERRED EMBODIMENT

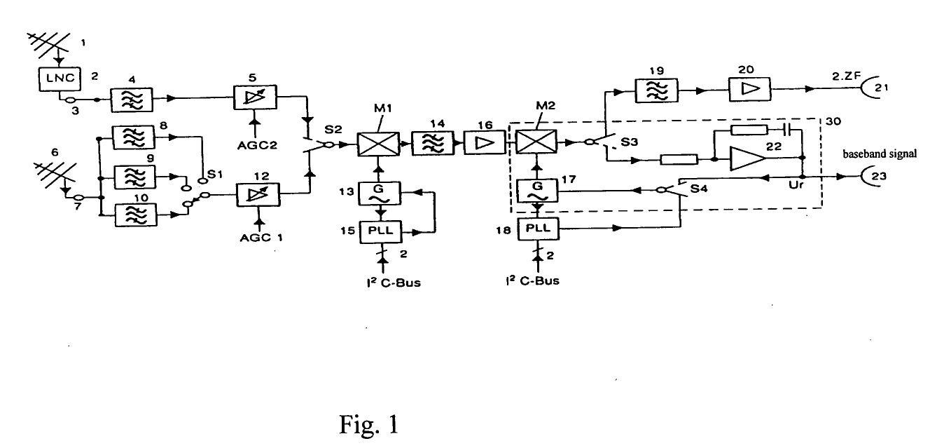

Referring to FIG. 1, a functional block diagram of a TV tuner of the present invention is shown. An FM broadcasting signal is transmitted to a band-pass filter 4 with transmission bands from 87.5 to 108 MHZ (FM) through an antenna input terminal. The signal is transmitted through an amplifier 5 controlled by an AGC2 (automatic gain control) and to a first input end of a change-over switch S2. A ground antenna or a cable 6 of a cable TV provides a ground TV signal with an approximate frequency range from 48.5 MHZ to 956 MHZ. The ground TV signal is inputted through an antenna input terminal 7 which connects with VHH and VHL band-pass filters 8, 9 with transmission bands from 48.5 MHz to 300 MHz (VHF) and connects with a band-pass filter 10 with transmission bands from 470 MHz to 956 MHz (UHF). A change-over switch S1 is used to select one of the band-pass filters 8, 9, 10 to electrically connect with an amplifier 12 which is controlled by an AGC1. The output end of the amplifier 12 electrically connects with a second input end of the change-over switch S2. An output end of the switch S2 connects with a first mixing stage M1. Each carrier wave is transformed to a first intermediate frequency through the first mixing stage M1. The first intermediate frequency is provided by a mixing oscillator 13 which is controlled by a PPL circuit 15. The PPL circuit 15 is controlled by a corresponding tuning command of an 12C bus. The signal with the first intermediate frequency is transmitted through a band-pass filter 14 and an amplifier 16 in series and to a second mixing stage M2 which connects with a mixing oscillator 17. In receiving a ground TV signal, the mixing oscillator 17 is controlled by a PPL circuit 18 which is controlled by the 12C bus. An output end of the second mixing stage M2 connects to a change-over switch S3. The switch S3 can be selectively connected to a band-pass filter 19 which connects to an intermediate frequency amplifier 20 of a second intermediate frequency stage and an output terminal 21 of the second intermediate frequency stage in series. The switch S3 can be selectively connected to an integrator 22 which connects to an output terminal 23. Through a change-over switch S4, a controlling input end of the mixing oscillator 17 can be selectively connected to an output end of the PPL circuit 18 or an output end of the integrator 22.

In FIG. 1, when the TV tuner receives the ground TV signal, the change-over switches S1-S4 work as shown in real lines, and when the tuner receives the FM broadcasting signal, the change-over switches S1-S4 work as shown in dashed lines.

In receiving the ground TV signal through the antenna 6, the twice frequency transformation is done by the mixing stages M1, M2. The side of the mixing stage M1, the mixing oscillator 13 and the PPL circuit 15 and the other side of the mixing stage M2, the mixing oscillator 17 and the PPL circuit 18 are operated in the similar way. The integrator 22 doesnot provide any functions due to the switches S3, S4. A second intermediate frequency is outputted to the output terminal 21 with a video carrier frequency being 45.75 MHZ and a voice carrier frequency being 41.25 MHZ. The output terminal 21 provides the signal to other device or component for further processing.

In receiving the FM broadcasting signal through the antenna 1, the mixing stage M2, the integrator 22 and the oscillator 17 cooperatively forms a PPL circuit. The output end of the mixing stage M2 is connected to an input end of the integrator 22. The output end of the integrator 22 is respectively connected to the controlling input end of the mixing oscillator 17 and the output terminal 23 for outputting a baseband signal. The PPL circuit is synchronized with the output signal of the amplifier 16 and therefore is functioned as an FM demodulator. The mixing stage M2 is functioned as a phase comparison stage, the integrator 22 is functioned as a lowpass filter or filter module and the oscillator 17 is functioned as a voltage controlled oscillator, whereby the mixing stage M2, the integrator 22 and the oscillator 17 are made up of three main parts of the PPL circuit thereby forming the FM demodulator. The controlling input end of the mixing oscillator 17 is connected to the output end of the integrator 22. The output voltage Ur of the integrator 22 is the frequency controlling voltage of oscillator 17, whereby the oscillator 17 oscillates according to the FM carrier frequency outputted by the amplifier 16. The frequency of the carrier is modulated by the amplifier 16. The output voltage Ur of the output terminal 23 is the output voltage of the baseband signal. The PPL circuit 18 doesnot provide any functions and the frequency of the oscillator 17 is controlled only by the output voltage Ur. According to the above operation manner, the oscillator 17 is tuned to the first intermediate frequency, the output carrier wave of the amplifier 16 is with a mute frequency. Thus, the mixing stage M2 doesnot provide the mixing frequency functions but forms a part of the FM PPL demodulator in an optimizing manner. The demodulator is shown in FIG. 1 by a dashed frame 30.

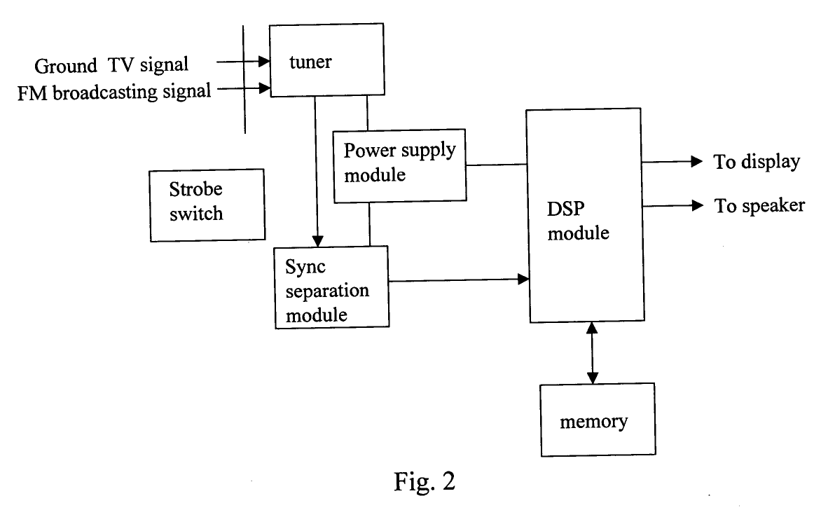

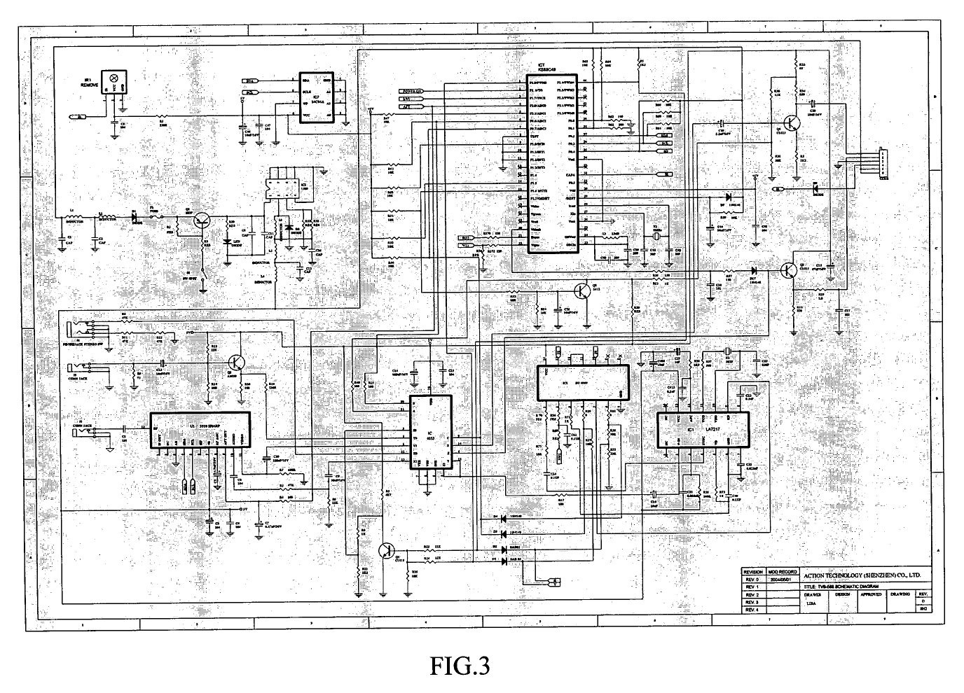

Referring to FIGS. 2 and 3, an application of the TV tuner of the present invention is shown with a functional block diagram and a circuit diagram thereof. A strobe switch is used to switch TV/FM signals and TV frequency channels and to control volume, programs, voice switch, frequency sweep, mute and so on. A sync separation module is used for sync separation of video signals outputted by the TV tuner and is used to load multilanguage on-screen display (OSD) information to the video signals. A memory is used to store the OSD information and dialog box information. A digital signal processing (DSP) module is used for memory switch of demodulated video signals and frequency channels and is used to adjust OSD. The DSP module also has functions of processing the OSD information and the dialog box information. A power supply module is used to supply power to the above modules. In use, the ground TV signal or the FM signal is selected through the strobe switch. The selected signal is processed through the tuner as described above. Then the tuned standard video and audio signals are outputted through the output terminal 21, 23 to the video separation module and the DSP module. The video signal is loaded with the OSD information. Finally, the processed video or audio signal is transmitted to a display or a speaker.

The circuit of the TV tuner as shown in FIG. 1 may be integrated in a chip. Of cause, a conventional chip may be used, such as a 2v8up5510 chip produced by Sharp. The memory may use a 24c04a memory. The power supply module may use a 1509DC-DC switching power supply. The DSP module may use an 8-bit 3F880AXZZ chip produced by Samsung.

A signal source is coupled to a 2V8UP5100 chip through the antenna. The signal from the signal source is transformed to 45.75M through the first mixing stage functioned as a frequency translator and then is transmitted to the PPL demodulator. The signal is processed to 41.25M through the second mixing stage functioned as one part of the PPL demodulator, more specifically as the phase comparison stage of the PPL circuit or demodulator. The mixing oscillator of the second mixing stage is preferred to tune to the first intermediate frequency. The mixing stage has two functions. One is functioned as a mixer for the second intermediate frequency transformation in receiving ground TV signals, and the other is functioned as a phase comparison stage of the PPL demodulator in receiving FM broadcasting signals.

Therefore, the TV tuner of the present invention can receive both of the ground TV signal and the FM broadcasting signal, thereby reducing a cost of a TV and increasing functions of the TV.

It is understood that the invention may be embodied in other forms without departing from the spirit thereof. Thus, the present examples and embodiments are to be considered in all respects as illustrative and not restrictive, and the invention is not to be limited to the details given herein.

1. A TV tuner comprising a first mixing stage for first intermediate frequency transformation; and a second mixing stage connected to the first mixing stage for second intermediate frequency transformation, wherein when the TV tuner receives a ground TV signal, the second mixing stage is functioned as a mixer for the second intermediate frequency transformation; and when the TV tuner receives an FM broadcasting signal, the second mixing stage is functioned as a phase comparison stage which connects to an integrator and a mixing oscillator thereby forming a PPL demodulator.

2. The TV tuner as claimed in claim 1, further comprising a strobe switch for switching the ground TV signal and the FM broadcasting signal.

3. The TV tuner as claimed in claim 2, wherein when the TV tuner receives the FM broadcasting signal, the mixing signal of the second mixing stage is tuned to the first intermediate frequency.

4. The TV tuner as claimed in claim 2, wherein an output end of the second mixing stage is connected to an input end of a second intermediate frequency stage through a change-over switch.

5. The TV tuner as claimed in claim 3, wherein an output end of the second mixing stage is connected to an input end of the integrator through a change-over switch, and an output end of the integrator is respectively connected to a controlling input end of the mixing oscillator and an output terminal for outputting a baseband signal.

6. The TV tuner as claimed in claim 4, wherein the TV tuner is connected to a DSP module.

7. The TV tuner as claimed in claim 6, wherein a DC-DC switching power supply supplies power to the TV tuner.

8. The TV tuner as claimed in claim 5, wherein the TV tuner is connected to a DSP module.

9. The TV tuner as claimed in claim 8, wherein a DC-DC switching power supply supplies power to the TV tuner.
